(19) United States
(12) Patent Application Publication
(10) Pub. No.: US 2011/0306266 A1
(43) Pub. Date: Dec. 15, 2011

(54) Sculpting device

(76) Inventor: Henry Goode Glass, Roanoke, VA (US)

(21) Appl. No.: 12/801,438

(22) Filed: Jun. 9, 2010

(51) Int. Cl. A63H 33/00; G01B 5/20

(52) U.S. Cl. 446/118; 33/561.1

(57) ABSTRACT

A sculpting device, including a number of fibers disposed parallel to one another and in sliding engagement with one another, is disclosed. A rubber band snugly encircles the fibers so as to hold the fibers together in the form of a bundle. The bundle has opposed ends and at least one of the opposed ends bears printed indicia.

### FIELD OF THE INVENTION

The present invention relates generally to apparatus for education and demonstration and, more particularly, to sculptures or crafts involving manual carving or shaping.

### BACKGROUND OF THE INVENTION

In U.S. Pat. No. 5,056,236, issued on Oct. 15, 1991, and incorporated for all purposes herein, I disclosed a sculpting device of uncomplicated construction. This device included a bundle of fibers packed into a hollow tube. The tube snugly, yet slidably, held the fibers with the internal surface of the tube being inwardly tapered its opposite ends for a better grip. By pushing on the ends of the fibers with a stylus, the fibers are moved to provide complementary, sculpted surfaces at opposite ends of the tube.

Over time, I have improved the sculpting device shown in the '236 patent. First, I now have a better way to hold the fibers together as a bundle thereby minimizing the likelihood that fibers will be shed from the tube. Also, I have placed images on the ends of the fiber bundles. If the image on the fibers is, say, a human face, the fibers can be manipulated to form an exceptionally lifelike, three-dimensional portrait. Outstanding 3-D effects can be obtained with landscapes, corporate logos, geometric designs and the like. The device carrying the improvements is fun to play with.

### SUMMARY OF THE INVENTION

In light of my improvements of the sculpting device described in my '236 patent, it is a principal object of mine to provide a sculpting device with at least one surface bearing an image that can be manipulated to take on any contour that a user may choose to apply. The image can, thus, be rendered with an especially lifelike, three-dimensional quality or in a whimsical way.

It is another object of the invention to provide a sculpting device with a bundle of fibers that is tightly held together yet that permits individual fibers to be selectively displaced to provide a three-dimensional, contoured projection.

It is still another object of the invention to provide a sculpting device of the type described that requires neither prolonged training and nor special tools to use. The sculpting device is easy and intuitive to use, requiring perhaps a few minutes of instruction and practice to master.

It is an object of the invention to provide improved features and arrangements thereof in a sculpting device for the purposes described which is lightweight in construction, inexpensive to manufacture, and fully dependable in use.

Briefly, my sculpting device achieves the intended objects by featuring a number of fibers disposed parallel to one another and in sliding engagement with one another. A rubber band snugly encircles the fibers so as to hold the fibers together in the form of a bundle. The bundle has opposed ends and at least one of the opposed ends bears printed indicia.

The foregoing and other objects, features, and advantages of the present invention will become readily apparent upon further review of the following detailed description of the sculpting device illustrated in the accompanying drawings.

### BRIEF DESCRIPTION OF THE DRAWINGS

The present invention may be more readily described with reference to the accompanying drawings, in which:

FIG. 1A is a perspective view of a sculpting device in accordance with the present invention.

FIG. 1B is an enlargement of the circled portion of FIG. 1A.

FIG. 2 is a top view of the sculpting device of FIG. 1.

FIG. 3 is a side view of the sculpting device with portions being broken away to reveal details thereof.

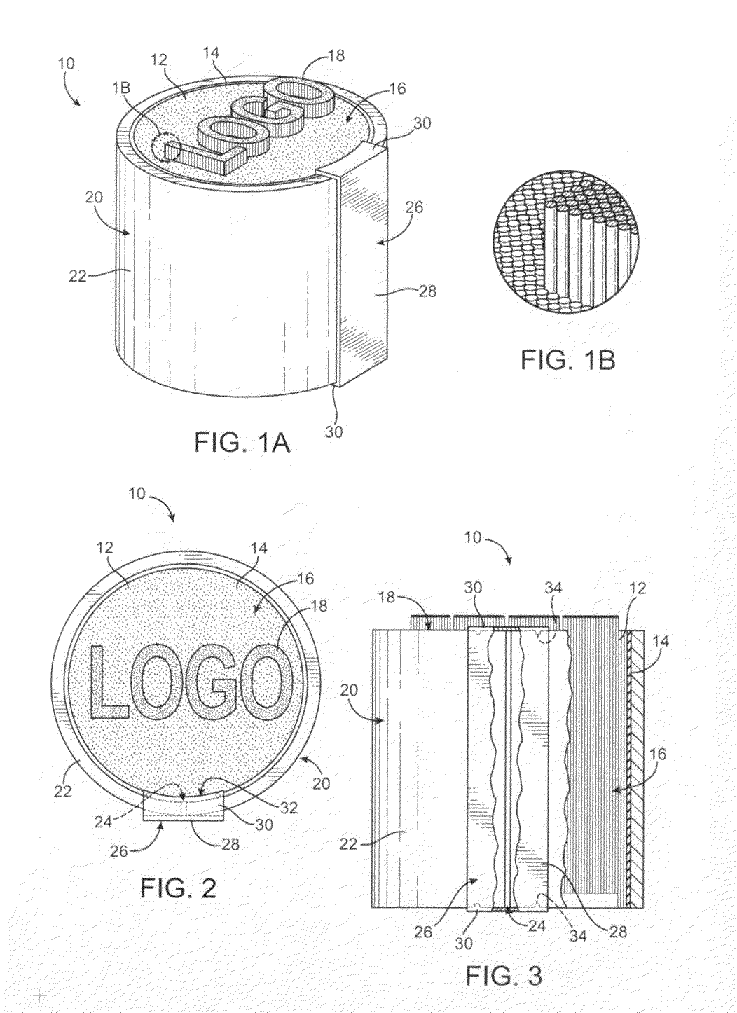

Similar reference characters denote corresponding features consistently throughout the accompanying drawings.

### DETAILED DESCRIPTION OF THE PREFERRED EMBODIMENT

Referring now to the FIGS., a sculpting device, constructed in accordance with the present invention, is shown at 10. The device 10 includes a plurality of individual fibers 12 held snugly, yet slidably, against one another by a rubber band 14. Collectively, the fibers 12 comprise a bundle 16 to one end of which printed indicia 18 are applied. The rubber band 14 is covered by a protective sleeve 20 that maintains the shape of the device 10 throughout its useful life.

The fibers 12 are formed from polypropylene or other suitable materials. They have polygonal cross sections to inhibit their sideways movement in the bundle 16, but can be provided with other cross sections like circles and ovals. The preferred cross section is shaped like an equilateral triangle measuring about 0.017 inches (0.43 mm) in height. The fibers 12 are about 3 inches (7.6 cm) in length.

The exact number of the fibers 12 employed in the bundle 16 is a matter of design choice. Nonetheless, making the bundle 16 about 2.75 inches (7 cm) in diameter, so that it can be easily grasped in the hand of a user, means that the bundle 16 will possess thousands of individual fibers 12 extending parallel to each other and the longitudinal axis of the device 10. This is acceptable since providing a large number of fibers 12 to the bundle 16 yields a device 10 that can render fine sculptural details.

Printed indicia 18 are provided to one or both ends of the bundle 16. The indicia 18 can take the form of: portraits of celebrities and other people, corporate logos, slogans, geometric designs, text, photographic images, and the like—the possibilities are limitless. The indicia 18 can include a combination of any number of colors or can be black and white only.

The application of paint, ink, or other colorants conveying the indicia 18 to the fibers 12 can be manually made with a rubber stamp, brush, or pen. Alternatively, machines like: pad printers, inkjet printers, and laser printers can, with some modifications, provide the indicia 18 to the bundle 16 as part of a large scale manufacturing process.

One printer found suitable for producing the indicia 18 is a PROMOTOR-4N sold by Diversified Printing Techniques of Charlotte, North Carolina. The PROMOTOR-4N is a pad printer having a horizontal table capable of supporting one or more bundles 16. A motorized shuttle moves the bundles 16 from one of four printing stations to another where each of the bundles 16 receives ink from a movable pad positioned above the table. Each pad applies one color of ink to a bundle 16 in a predetermined pattern so that multi-color printing requires stops of the shuttle at two to four printing stations. The movement of the bundles 16 from one station to the 2 0 next takes only a few seconds, but since the ink is quick drying, it does not bleed. Printing indicia 18 on the bundles 16, therefore, requires little time to complete.

The bundle 16 is held in a round shape by the rubber band 14 that is stretched around the plurality of fibers 12 of bundle 16. The rubber band 14 is a short length of natural rubber formed in the shape of a loop. The rubber band 14 has three basic dimensions: length, thickness, and width. The length of rubber band 14 is one-half of its circumference or about 4 inches (10.2 cm). The thickness of the rubber band 14 is about 1/32 of an inch (1 mm). The width of the band 14 is the same as the length of the fibers 12 or 3 inches (7.6 cm). The rubber band 14 tends to pack the fibers 12 close together along their entire lengths to increase the frictional force between the fibers 12 so that the fibers 12 will not freely slide relative to each other even if the device 10 is shaken or inadvertently dropped.

The protective sleeve 20 includes a slotted tube 22. The tube 22 is molded from resilient plastic and is dimensioned to grasp the bundle 16 bound by rubber band 14 snugly within its confines. The tube 22 has an internal diameter of about 2 13/16 inches (7.1 cm), a thickness of about ⅛ of an inch (3.2 mm) and a width of about 3 inches (7.6 cm). As shown, the tube 22 has a narrow slot 24 that runs from its top to its bottom that, by manually enlarging the slot 24 somewhat by pulling on opposite sides of the tube 22, that facilitates the placing of the bundle 16 within the tube 22 at the time of it manufacture.

In addition to the slotted tube 22, the sleeve 20 also includes a slot cover 26. The slot cover 26, has a rectangular, base plate 28 that extends from the top to the bottom of the tube 22 and that has a width sufficient to cover the slot 24 in the tube 22. A pair of end plates 30 is affixed to the base plate 28 so as to provide the slot cover 26 with a shallow, U-shaped configuration. Each of the end plates 30 has a shallow concavity 32 in its free edge with a radius of curvature like that of the slotted tube 22 to provide clearance so that nearby fibers 12 can be pushed outwardly from the bundle 16. At the opposite ends of each concavity 32, each end plate 30 is provided with an inwardly directed pin 34. When the base plate 28 is pressed closely against the exterior of the tube 22, the pins 34 “snap” over the top and bottom of the tube 22 thereby retaining the cover 26 in firm engagement with the tube 22.

The use of sculpting device 10 is straightforward. First, with none of the fibers 12 projecting from the bundle 16 and indicia 18 being held flat, a user pushes selected fibers 12 outwardly from one end of the bundle 16 by pushing on the ends of the fibers 12 present at the opposite end of the bundle 16. To achieve the desired relief in the fibers 12 (making the term “LOGO” shown by the indicia 18 project upwardly), some of the fibers 12 are moved outwardly from the bundle 16. Any implement like: fingers, pencils, pens, or styluses can be used to move the fibers 12.

When sculpting is finished, the device 10 is placed in an upright position on a horizontal supporting surface or it is tipped on its side with slot cover 26 serving as a base. If desired, the fibers 12 can be pressed back into the rubber band 14 at a later time and the sculpting process can be repeated to achieve a new effect. The rubber band 14 and the sleeve 20 ensure that the finished sculpture will retain its shape until the bundle 16 is reformed by a user.

There are several ways to permanently maintain the relief provided to the fibers 12 of a bundle 16 by a user. One way involves the end of the bundle 16 remote from the indicia 18 being heated with a small blowtorch to melt the fibers 12 together. Afterward, any concavities in the just-heated end can be filled with wax, epoxy resin, or other suitable material. Alternatively, the end of the bundle 16, away from the indicia 18 having some sculpted relief, can be cut flat with a saw. The resulting bundle 16 will contain fibers 12 of assorted lengths and is well suited for use in- low cost, factory-produced sculptures.

While the sculpting device 10 has been described with a high degree of particularity, it will be appreciated by those skilled in the field that modifications can be made to it. For example, the protective sleeve 20 need not have a circular outline, but can be any desired shape such as an oval, rectangle, or square. Furthermore, embodiments of the device 10 can be produced without the sleeve 20 and with the rubber band 14 only holding the bundle 16 in shape. Therefore, it is to be understood that the present invention is not limited solely to sculpting device 10, but encompasses any and all sculpting devices within the scope of the following claims.

I claim:

1. A sculpting device, comprising:
a plurality of fibers being disposed parallel to one another and in being in sliding engagement with one another; and,
a rubber band snugly encircling said plurality of fibers so as to hold said fibers together as a bundle, said bundle having opposed ends and at least one of said opposed ends bearing printed indicia.

2. The sculpting device according to claim 1 further comprising a protective sleeve snugly encircling and covering said rubber band.

3. The sculpting device according to claim 2 wherein said protective sleeve includes a slotted tube having a slot extending the length thereof.

4. The sculpting device according to claim 3 wherein said protective sleeve further includes a slot cover covering said slot in said slotted tube.
